(19) United States
(12) Patent Application Publication
(10) Pub. No.: US 2017/0166490 A1
(43) Pub. Date: Jun. 15, 2017

(54) FILMS CONTAINING NUTRIENTS OR COMPONENTS FOR USE BY SOIL OR PLANTS

(71) Applicant: Organix Solutions, LLC, Delano, MN (US)

(72) Inventor: Stuart MacDonald, Minneapolis, MN (US)

(21) Appl. No.: 15/367,805

(22) Filed: Dec. 2, 2016

Related U.S. Application Data
(60) Provisional application No. 62/267,015, filed on Dec. 14, 2015.

(51) Int. Cl. C05G 3/00; A01N 25/10; C05C 11/00; B29C 47/00; C05D 9/02; C05D 1/00; C05D 3/00; C08J 5/18; A01N 25/34; C05B 17/00

(52) U.S. Cl. CPC C05G 3/0052; A01N 25/34; A01N 25/10; C05C 11/00; C05B 17/00; C05D 9/02; C05D 1/00; C05D 3/00; C08J 5/18; B29C 47/0004; B29C 47/0023; C08J 2300/16; B29L 2007/00

(57) ABSTRACT

Polymer films containing nutrients and/or components for use by soil, plants and/or animals are biodegradable and compostable. Film compositions may include bio-based and fossil-based polymers along with nutrients and other components that can be utilized by soil, plants, animals, as well as pigments and additives. The films may be configured as three-layer coextruded films with two outside layers and an inside layer therebetween. The films of the present disclosure may be produced using blown film processes. The films are used in agricultural or other growing settings and provide a biodegradable, compostable film that delivers nutrients and/or components to soil, plants and/or animals over the course of and following film degradation.

### CROSS REFERENCE TO RELATED APPLICATION(S)

This application claims priority to provisional application Ser. No. 62/267,015, filed on Dec. 14, 2015 with the title “Films Containing Nutrients or Components for Use by Soil, Plants and/or Animals,” the entire contents of which is herein incorporated by reference in its entirety.

### TECHNICAL FIELD

The present disclosure provides films that include nutrients and/or components for use by soil, plants and/or animals and methods for their production and use.

### BACKGROUND

Agricultural films are commonly petroleum-based films that do not degrade over time and disposing of these films is difficult. The use of biodegradable films that are compostable are therefore desirable because these materials may compost in their original position (e.g., in a field) or may be removed and readily composted. Particularly, biodegradable films degrade into CO₂ and biomass. Some biodegradable films include ester bonds that are degraded into sugars by hydrolysis in the presence of water, and these sugars are digestible by microorganisms in the soil to give off CO₂, leaving biomass. For instance, when biodegradable films containing starch contact soil and/or water, the starch is attacked by soil microbes, leaving behind a porous structure that further degrades enzymatically. The biodegradability of the films avoids the requirement of removing and disposing of the films in landfills.

### SUMMARY

Polymer films having nutrients and/or components incorporated therein for use by soil, plants and/or animals, and methods of their production and use are provided herein.

According to one embodiment, a film for use in agriculture or horticulture includes a cross-linked biodegradable polymer film and one or more nutrients or components within the cross-linked film for use by one or more of soil or plants. The film is adapted to be flexible and to release the one or more nutrients or components after deployment.

In certain implementations and alternatives, the nutrients or components includes at least one of: nitrogen, phosphorous, fertilizers, metals, micronutrients, herbicides, silicon dioxide, alumina, calcium oxide, ferric oxide or potassium oxide. Such nutrients or components are not naturally present in the polymer forming the polymer film, nor are such nutrients or components formed from degradation of the polymer film. In addition or alternatively, the biodegradable polymer is a bio-based polymer alone or in combination with a fossil-based polymer. The biodegradable polymer may include polylactic acid (PLA) and polybutyrate (PBAT). The film may have a thickness of about 0.5 mils to about 1.0 mil, may be a three-layer coextruded film comprising two outside layers and an inside layer therebetween, and each of the outside layers may account for about 15 to 20 percent of the total thickness of the film, and the inside layer may account for about 60 to 70 percent of the total thickness of the film. The nutrients or components may account for about 0.1 to about 40 wt % of the film. The outside layers of the three-layer film may contain about 15 to about 20 wt % of the one or more nutrients or components, and the inside layer may contain about 60 to about 70 wt % of the one or more nutrients or components. The film may be continuous. In addition or alternatively, the film may include structural modifications.

According to another embodiment, a method of using a film in agriculture or horticulture settings involves deploying the film over a growing media. The film may include a cross-linked biodegradable polymer film and one or more nutrients or components within the cross-linked film for use by one or more of soil or plants. The film may be adapted to be flexible and to release the one or more nutrients or components after deployment. The one or more nutrients or components may include those described herein.

According to yet another embodiment, a method of producing a blown film having one or more nutrients or components incorporated therein may involve feeding into a hopper of a blown film extruder polymer resin pellets and compounded pellets comprised of the one or more nutrients or components and a polymer resin; heating the pellets into a molten resin; extruding the molten resin into a continuous film tube; inflating the continuous tube; and slitting the tube to form the film, where the film is adapted to be flexible and to release the one or more nutrients or components contained within the film after deployment.

According to certain implementations and alternatives, the polymer resin of the compounded pellets may be PLA and/or PBAT. In addition or alternatively, the one or more nutrients or components may account for 1 to 50 wt % of the compounded pellets.

In some approaches, prior to the step of heating, the pellets may enter a gravimetric blending/feeding system.

This summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments of the invention and illustrated in the accompanying drawings.

### BRIEF DESCRIPTION OF THE DRAWING

FIG. 1 is a flow diagram of a method for producing a blown film having one or more nutrients or components incorporated therein, according to certain implementations.

### DETAILED DESCRIPTION

The present disclosure provides added benefits to biodegradable films. Particularly, disclosed herein are films containing nutrients and/or components for use by soil, plants and/or animals that are biodegradable and compostable, and methods of their production and use. As provided herein, such nutrients or components are not naturally present in the polymer forming the polymer film, nor are such nutrients or components formed from degradation of the polymer film. Use of such films may reduce the need for producers to apply nutrients, such as fertilizers and micronutrients, and other components, such as herbicides, to soil, for instance, prior to planting. Such nutrients and/or components delivered from the film may add benefit to the soil and/or to a crop plant throughout a crop's growing cycle.

The films of the present disclosure may be used in agricultural, horticultural and aquaculture settings. Agricultural films may further be configured as specialty films such as mulching films and low tunnel films. Such films may be used to cover the soil and vegetation in order to, for instance, improve yield, improve protection against weeds, and to control evaporation.

Polymer Film Compositions:

The compositions of the disclosed films may include combinations of polymers, nutrients and other components that can be used by soil, plants and/or animals, as well as optional pigments and additives.

a. Polymers:

The polymers in the disclosed films may be one or more bio-based polymers or a combination of bio-based and fossil-based polymers (e.g., fossil-based bio-polymers) and may be biodegradable and/or compostable. The polymers may include polylactic acid (PLA) derived from hydrolysis of corn starch, polyhydroxyalkanoate polymers (PHAs) derived from fermentation using renewable carbon-based feedstock, other bio-based polymers such as starch and wood-based polymers, polybutyrate (PBAT—polybutyrate adipate terephthalate), and polybutylene succinate (PBS).

In some implementations, the bio-based polymer may account for about 100 wt % of the polymer composition. Alternatively, the bio-based polymer may form a portion of the polymer composition. For instance, PLA has high yield strength (49 MPa) and flexural strength (70 MPa) giving it a high elasticity modulus, but includes a tensile modulus of 3.2 GPa and an elongation of 2.5% giving it a high stiffness. In order to provide the polymer portion of the film with added flexibility, PLA may be compounded or otherwise combined (e.g., dry blended) with petroleum products to provide a film with flexibility and ester bonds needed for hydrolysis during degradation. Alternatively, in some implementations, polybutyrate (PBAT), a copolyester of adipic acid, 1,4-butanediol and dimethyl terephthalate, may be combined with PLA or another bio-based polymer at various ratios to form the polymer portion of the film. In some embodiments, PBAT may account for between about 35 to about 60 wt % of the polymer composition, while PLA may account for about 40 to about 65 wt %.

In other embodiments, the polymer composition may include PBAT at about 1 to about 80 wt %, about 1 to about 70 wt %, about 1 to about 60 wt %, about 1 to about 50 wt %, about 1 to about 40 wt %, about 1 to about 30 wt %, about 1 to about 20 wt %, about 1 to about 10 wt %, about 1 to about 5 wt %, about 5 to about 10 wt %, about 10 to about 20 wt %, about 20 to about 40 wt %, about 40 to about 70 wt %, about 40 to about 60 wt %, about 40 to about 50 wt %, about 50 to about 80 wt %, about 50 to about 70 wt %, about 50 to about 60 wt %, about 60 to about 80 wt %, about 60 to about 70 wt % or about 70 to 80 wt % of the polymer composition. In such embodiments, the polymer composition may include PLA, PHA, or other bio-based polymers at about 30 to about 99 wt %, about 40 to about 99 wt %, about 50 to about 99 wt %, about 60 to about 99 wt %, about 70 to about 99 wt %, about 80 to about 99 wt %, about 90 to about 99 wt %, about 30 to about 70 wt %, about 30 to about 60 wt %, about 30 to about 50 wt %, about 30 to about 40 wt %, about 40 to about 80 wt %, about 40 to about 70 wt %, about 40 to about 60 wt %, about 40 to about 50 wt %, about 50 to about 80 wt %, about 50 to about 70 wt %, about 50 to about 60 wt %, about 60 to about 80 wt %, about 60 to about 70 wt % or about 70 to 80 wt % of the polymer composition. In a particular implementation, the polymer portion of the film may be in BASF's Ecovio™ M2351. The polymer portion of the biodegradable films may be soil-compostable according to European Standard EN 13432.

b. Nutrients and Components for Use by Soil, Plants and/or Animals:

Nutrients and other components for incorporation into the polymer portion of the films and subsequent use by soil, plants and/or animals, may include nitrogen, phosphorous and potassium (e.g., NPK fertilizer), metals including micronutrients, and/or herbicides. Metals and micronutrients may include metal oxides, which include but are not limited to silicon (e.g., silicon dioxide (SiO₂)), aluminum (e.g., alumina (Al₂O₃)), potassium (e.g., potassium oxide (K₂O)), calcium (e.g., calcium oxide (CaO)), sodium oxide (Na₂O), ferric oxide (Fe₂O₃), barium (e.g., barium oxide (BaO)), magnesium (e.g., magnesium oxide (MgO)), manganese (e.g., manganese oxide (MnO₂)), phosphorous (e.g., phosphorous pentoxide (P₂O₅)), strontium (e.g., strontium oxide (SrO)), sulfur (e.g., sulfur trioxide (SO₃)), titanium (e.g., titanium dioxide (TiO₂)) alone or in any combination. Soil, plant and/or animal nutrients may additionally or alternatively include components such as carbon, chlorine, antimony, arsenic, beryllium, bismuth, boron, bromine, cadmium, cerium, cesium, chromium, cobalt, copper, dysprosium, erbium, europium, fluorine, gadolinium, gallium, germanium, gold, hafnium, holmium, indium, iodine, lanthanum, lead, lithium, lutetium, mercury, molybdenum, neodymium, nickel, niobium, palladium, praseodymium, rhenium, rhodium, rubidium, ruthenium, samarium, scandium, selenium, silver, strontium, sulfur, tantalum, tellurium, terbium, thallium, thorium, thulium, tin, tungsten, uranium, vanadium, ytterbium, yttrium, zinc, and zirconium, alone or in any combination. In some implementations, the nutrients and other components may be in the form of a powder, such as a micronized powder. In some implementations, the films may be free of any of the preceding soil, plant and/or animal nutrients.

The nutrients and/or components may be present in the film at about 0.1 to about 45 wt % of the film, 0.1 to about 40 wt % of the film, about 1 to about 30 wt %, about 1 to about 20 wt %, about 1 to about 10 wt %, about 1 to about 5 wt %, about 5 to about 30 wt %, about 5 to about 20 wt %, about 5 to about 10 wt %, about 10 to about 40 wt %, about 10 to about 30 wt %, about 10 to about 20 wt %, about 15 to about 45 wt %, about 15 to about 35 wt %, about 15 to about 25 wt %, about 15 to 20 wt %, about 20 to 40 wt %, about 20 to 30 wt %, or about 20 to 25 wt % of the film.

The nutrients and/or components disclosed herein may be present at 0.001 to 100 wt % of the total weight of the nutrients and/or components. In one example, the nutrients and/or components include silicon dioxide in an amount of at least about 50 and up to about 75 wt %. In addition or alternatively, alumina may be included at about 10 to about 20 wt % of the nutrients and/or components. Calcium oxide, ferric oxide, potassium oxide may be present at about 1 to about 10 wt % of the nutrients and/or components.

The soil, plant and/or animal nutrients may be provided as a compound, a particulate, a prill, may be micronized and/or granulated for use in subsequent film production processes.

When provided as a compound, the nutrients and/or components may be prepared from a compounding process, which involves melting base polymer(s), such as the polymers of the present disclosure, and incorporating one or more of the nutrients and/or components. In a compounding system, polymer resin(s) and additive(s) such as a powder of nutrients and/or compounds are fed through an extruder where they are combined in a homogenous mixture. The melted compound exits the extruder in strands, which are cooled and pelleted. The pellets may be used in combination with polymer mixtures or pellets in the film production process. In some implementations, the compounded nutrient pellets may be composed of PLA and/or PBAT polymer resins. In some implementations, the nutrients and/or components may be compounded with polymers at a nutrient loading level of 1 to 50 wt % of the compounded pellet. In more particular implementations, nutrient and/or component loading may be at about 0.1 to about 10 wt %, about 10 to about 20 wt %, about 20 to about 30 wt %, about 30 to about 40 wt %, or about 40 to about 50 wt % of the compounded pellet. The compounded pellet may have substantially the same size as polymer pellets fed into a blown film production system, as described herein. For instance, the polymer pellets may range in size from a width of ⅛ in. and a thickness of 3/16 in.

Particulates or prills may be composed of a mixture of nutrients and/or components and optionally polymer resins. In some implementations, the pellets may be coated with nutrients and/or components. In certain implementations, micronized nutrients and/or components may be about 1 to 100 microns, 1 to 75 microns, or up to about 10, 20, 30, 40, 50, 60, 70 or 80 microns. In further implementations, the micronized nutrients and/or components may be present in the compounded form.

c. Pigments:

The compositions of the disclosed films may include pigment for imparting color to the films. One or more pigments may be present at about 0.01 to 10 wt % of the film, about 1 to 8 wt % of the film, or about 4 to 8 wt % of the film.

d. Additives:

The compositions of the disclosed films may include additives at about 1 wt % of the film, such as additives for UV absorption, UV inhibition, and fillers.

Polymer Film Configurations:

The films of the present disclosure may be configured as extruded films, and may for instance, be configured as three-layer coextruded films with two outside layers (e.g., opposing exterior layers) and an inside layer therebetween. The layer or layers of the films of the present disclosure may include combinations of one or more of the polymers, pigments, nutrients and/or components for use by soil, plants and/or animals, and optionally additives. The cross-linked polymers hold the nutrients and/or components within the film. The film may serve as scaffolding, and the nutrients and/or components may be integrated in and trapped by the polymer film. The embedded nutrients and/or components may remain substantially in their original form when embedded in the polymer film. Particularly, the nutrients and/or components may not react with the polymer film components, resulting in a polymer film with nutrients and/or components available for use by the soil, plants and/or animals upon their release by the polymer. In other words, the nutrients and/or components may not be cross-linked with the polymers and may be unbound, or free of polymer linkages, thereby enabling subsequent release.

The films may have a nominal thickness of about 0.5 to about 1.0 mil, about 0.6 to about 0.9 mils, or about 0.7 to about 0.8 mils. Each of the outside layers may account for about 15 to about 20 percent of the total thickness of the film, and the inside layer may account for about 60 to about 70 percent of the total thickness of the film. The films may be continuous, or alternatively, may have structural modifications such as slits or openings defined by the film. In another example, each of the outside layers may account for about 15 to about 50 percent of the total thickness of the film, and the inside layer may account for about 35 to 45 percent of the total thickness of the film. In yet another example, each of the outside layers may account for about 30 percent of the total thickness of the film, while the inside layer accounts for about 40 percent of the total thickness of the film.

The level of nutrients and/or components for use by soil, plants and/or animals in the outside and inside layers of the polymer film may vary depending, for instance, on the film's application of use and thickness. In some embodiments, the outside layers may each contain about 15 to about 20% of the total weight of the nutrients and/or components in the film, while the inside layer may contain the balance of about 60 to about 70% of the total weight of the nutrients and/or components in the film. In a more particular embodiment, the outside layers may each contain about 16.5%, and the inside layer may contain about 66%, of the total weight of the nutrients and/or components in the film.

In some embodiments, the film may contain polymers at about 60 to about 99 wt % of the film, pigment at about 0 to about 10 wt % of the film, and nutrients and/or components for use by soil, plants and/or animals at about 1 to about 40 wt % of the film.

In a more particular embodiment, the film may contain polymers at about 70 to about 80 wt % of the film, pigment at about 1 to about 8 wt % of the film, and nutrients and/or components for use by soil, plants and/or animals at about 19 to about 29 wt % of the film.

In another embodiment, the film may contain polymers at about 75 to about 80 wt % of the film, pigment at about 4 to about 8 wt % of the film, and nutrients and/or components for use by soil, plants and/or animals at about 16 to about 21 wt % of the film.

In yet another embodiment, the film may contain polymers at about 69 to about 77 wt % of the film, pigment at about 1 to about 8 wt % of the film, and nutrients and/or components for use by soil, plants and/or animals at about 22 to about 30 wt % of the film. Those skilled in the art will appreciate that the film composition may include other levels of the polymer, pigment and nutrients and/or components based on factors such as film thickness, application of use, and nutrient and/or component compositions of the film.

In some implementations, one or more of the inside layer or the two outside layers may be free of pigment, of nutrients and/or components, or of additives. Further, the composition of the inside or outside layers may consist of, or consist essentially of, the aforementioned polymer film components. Some components such as certain additives and fillers may be present in the disclosed compositions, for instance, as necessary components for the manufacture and distribution of the polymer films without altering the effectiveness of the films to biodegrade, compost and to release the nutrients and/or components to the soil, plants and/or animals.

Polymer Film Production Process:

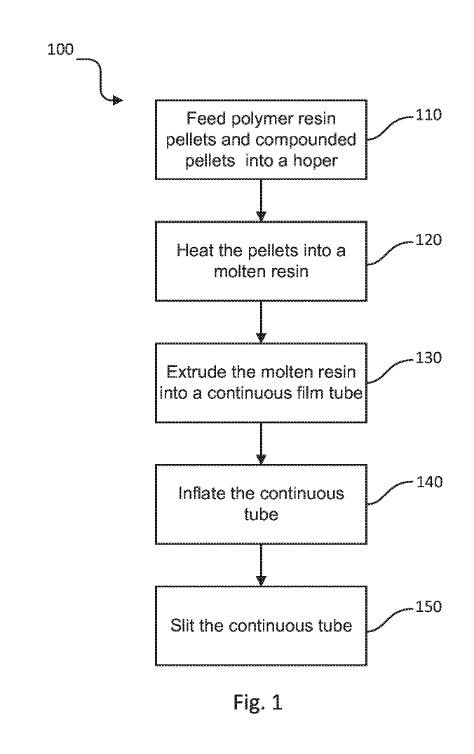

The films of the present disclosure may be produced using blown film processes. Such processes of producing blown films involve extruding molten resin into a continuous tube. FIG. 1 illustrates a flow diagram of a method 100 for producing a blown film having one or more nutrients or components incorporated therein, according to certain implementations. According to FIG. 1, polymer resin pellets and compounded pellets are fed into a hoper of an extruder (110). For instance, pellets, including compounded nutrient and/or component pellets described herein, compostable resin pellets, and pigment pellets (e.g. color master batches), are fed separately through segregated hoppers into a gravimetric blending/feeding system at selected rates to ensure a correct ratio of nutrients and/or components, compostable resin and pigment s present for the blown film. The pellets undergo mixing to generate a homogenous mixture. The homogenized pellets may be heated into a molten resin (120). The mixture may be passed to an extruder portion where friction and heat generated by the extruder causes the pellets to melt and the molten contents to be forced through a die to form a tube (130). The tube may be inflated (140), for instance, to increase its diameter thereby decreasing the film gauge. During the step of inflation, the tube may be drawn away from the die by, for instance, a top nip roller, further decreasing film gauge. The tube, sometimes referred to as a “bubble,” may be slit (150) and then opened. The opened tube of blown film may then be flattened by collapsing frames. The film may be drawn through nip rolls, over idler rolls and/or provided to a winder to produce a finished roll of film. The polymer films may have a shelf life of about 2 years.

Polymer Film Uses:

The films of the present disclosure may be used in agricultural, horticultural, aquaculture or other growing settings and provide a biodegradable, compostable film that delivers nutrients and/or components to soil, plants and/or animals over the course of and following film degradation. Particularly, it has been discovered that reduced levels of nutrients and/or components may be required compared to traditional application rates due to the ability of the film to slowly release the nutrients and/or components over the course of degradation due to the close proximity of the film to the soil and vegetation that enables the released nutrients and/or components to remain proximate to such soil and/or vegetation until uptake. For instance, where a nutrient or other component is recommended for traditional soil applications at 75 pounds per acre, films incorporating the nutrient and/or components of the present disclosure may require only 50 pounds per acre to reach the same results. In some implementations, the nutrients and/or components may be present in the films at about 0.001 to about 0.01 lbs. per ft.³, about 0.0005 to about 0.001 lbs. per ft.³, or about 0.0005 to about 0.0025 lbs. per ft.³.

As described, the films of the present disclosure may have a shelf life of about 2 years, and once the film is deployed over a growing media, e.g., soil, vegetation (crops, gardens), water or combinations, it begins biodegradation immediately. During degradation, the nutrients and/or components are released from the film making them available for absorption by soil, for uptake by plants and/or for ingestion by animals. Upon release and prior to absorption, uptake or intake, the released nutrients and/or components are protected by the film. The physical protection the film layer provides to the nutrients and/or components helps prevent their runoff and drift and is another reason reduced levels of the nutrients and/or components may be required compared to traditional application rates.

Degradation of the film and release of the nutrients and/or components continues over the course of about 3 to 6 months, which typically corresponds to a crop's growing cycle. The slow-release of the nutrients and/or components over the course of the growing cycle enables soil absorption and plant uptake throughout the crop's growing cycle.

Upon being tilled, the polymer film rapidly degrades and may be substantially degraded or decomposed about 6 months after tilling. The rapid film degradation further releases the nutrients and/or components enabling absorption by the soil, and due to the proximity of the released nutrients and/or components to the soil, reduces the risk of the nutrients and/or components being washed or blown away.

The films of the present disclosure may contain GRAS components and may be edible and may further provide nutrients to animals, such as grazing animals. Due to being edible, the animals may be present in areas that may have otherwise been unavailable due to the non-edible nature of petroleum-based films. In addition, the nutrients and/or components of the films may be tailored for the animal or selected for use by a combination of animals, plants and/or soil.

As understood by those skilled in the art, modifications can also be made to adapt these teachings to different situations and applications, and to the use of other materials and methods, without departing from the essential scope of the present disclosure. The disclosure is thus not limited to the particular examples that are disclosed, and encompasses all of the embodiments falling within the subject matter of the appended claims.

What is claimed is:

1. A film for use in agriculture or horticulture comprising a cross-linked biodegradable polymer film and one or more nutrients or components within the cross-linked film for use by one or more of soil or plants, the film adapted to be flexible and to release the one or more nutrients or components after deployment.

2. The film of claim 1, wherein the one or more nutrients or components comprises at least one of: nitrogen, phosphorous, fertilizers, metals, micronutrients, herbicides, silicon dioxide, alumina, calcium oxide, ferric oxide or potassium oxide.

3. The film of claim 1, wherein the biodegradable polymer comprises a composition of bio-based and fossil-based polymers.

4. The film of claim 3, wherein the biodegradable polymer comprises polylactic acid (PLA) and polybutyrate (PBAT).

5. The film of claim 1, wherein a thickness of the film is about 0.5 mils to about 1.0 mil.

6. The film of claim 1, wherein the film is a three-layer coextruded film comprising two outside layers and an inside layer therebetween.

7. The film of claim 6, wherein each of the outside layers account for about 15 to 20 percent of the total thickness of the film, and wherein the inside layer accounts for about 60 to 70 percent of the total thickness of the film.

8. The film of claim 7, wherein a thickness of the film is about 0.5 mils to about 1.0 mil.

9. The film of claim 8, wherein the one or more nutrients or components is in an amount of about 0.1 to about 40 wt % of the film.

10. The film of claim 9, wherein each of the outside layers contains about 15 to about 20 wt % of the one or more nutrients or components, and wherein the inside layer contains about 60 to about 70 wt % of the one or more nutrients or components.

11. The film of claim 1, wherein the film is continuous.

12. The film of claim 1, wherein the film comprises structural modifications.

13. A method of using a film in agriculture or horticulture settings, comprising:
deploying the film over a growing media, wherein the agricultural film comprises a cross-linked biodegradable polymer film and one or more nutrients or components incorporated within the cross-linked film for use by one or more of soil or plants, the film adapted to be flexible and to release the one or more nutrients or components after deployment.

14. The method of claim 13, wherein the one or more nutrients or components comprises at least one of: nitrogen, phosphorous, fertilizers, metals, micronutrients, herbicides, silicon dioxide, alumina, calcium oxide, ferric oxide or potassium oxide.

15. A method of producing a blown film having one or more nutrients or components incorporated therein, the method comprising:
feeding into a hopper of a blown film extruder polymer resin pellets and compounded pellets comprised of the one or more nutrients or components and a polymer resin;
heating the pellets into a molten resin;
extruding the molten resin into a continuous film tube;
inflating the continuous tube; and
slitting the continuous tube to form the film,
wherein the film is adapted to be flexible and to release the one or more nutrients or components contained within the film after deployment.

16. The method of claim 15, wherein the polymer resin of the compounded pellets comprises one or more of PLA or PBAT.

17. The method of claim 15, wherein the one or more nutrients or components account for 1 to 50 wt % of the compounded pellets.

18. The method of claim 15, wherein prior to the step of heating, the pellets enter a gravimetric blending/feeding system.

19. The method of claim 15, wherein the film has a thickness of about 0.5 mils to about 1.0 mil.
